(19) United States
(12) Patent Application Publication
(10) Pub. No.: US 2015/0290758 A1
(43) Pub. Date: Oct. 15, 2015

(54) COOLING SYSTEM FOR WORKING FLUID OF MACHINE TOOL AND METHOD FOR USING THEREOF

(71) Applicant: ACCUTEX TECHNOLOGIES CO., LTD., Taichung City (TW)

(72) Inventor: JUI FANG LIANG, TAICHUNG CITY (TW)

(21) Appl. No.: 14/514,971

(22) Filed: Oct. 15, 2014

(30) Foreign Application Priority Data
Apr. 15, 2014 (TW) 103113745

(51) Int. Cl. B23Q 11/14; B23Q 11/12

(52) U.S. Cl. CPC B23Q 11/141; B23Q 11/126

(57) ABSTRACT

A cooling system for working fluid of machine tool is assembled with a temperature sensing and controlling device for controlling the operation modes of a cooling host thereof. The cooling host is a commercial available cooling host. The cooling host delivers refrigerants to a heat exchanger via a refrigerant circulation pipeline so at to cool down the working fluid, and the cooling host can be freely replaced by any commercial available cooling host based on the damage condition thereof. Based on this, the cooling system according to the present invention is capable of being assembled to various machine tools and capable of using various commercial available cooling hosts for the operation of the system.

### BACKGROUND OF THE INVENTION

1. Field of the Invention

The present invention relates to an application using commercial available air conditioner as a cooling host to cool down a machine tool via liquid media to undergo heat exchange, and relates to a fluid sensing device, and more particularly to a machine tool which applies a large amount of working fluid during operation, and the working fluid is applied in machining and cooling thus sufficiently improving the performance of the machine tool.

2. Description of the Prior Art

During the operation of a machine tool, heats are generated unavoidably and thus resulting in minor deformation of the machine tool itself or the machine parts. However, such small-scaled deformation can lead the reduction of the machining precision be a severe issue in high precision industrial fields. Therefore, for high precision machine tools, it is important to reduce the influences of the temperature to the machining performance. Besides applying heat conduction structures and heat dissipation mechanism design in the machine tool, most machine tools utilize working fluids which perform great heat conduction and flowability as media for heat elimination.

Since the working fluid is a major media for heat removal, the heat dissipation and temperature cooling the working fluid become one of the important factors determining the machining stability. As referring to FIG. 1, in conventional, the temperature cooling of the working fluid is accomplished by firstly connecting the working fluid storage tank 501 of the machine tool 600 with a specified cooling machine 700, and the temperature of the working fluid in the working fluid storage tank 501 is monitored by a controller of the machine tool 600, when the temperature of the working fluid is risen to an upper limit of a defined value, the pumping device within the machine tool 600 or the cooling machine 700 will be driven to deliver the working fluid to the cooling machine 700 via pipelines for cooling and then to deliver back to the working fluid storage tank 501.

However, in the conventional, the cooling machine 700 is custom made to the machine tool 600 only, so that the machine tool 600 can only utilize the cooling machine 700 to undergo the cooling of the working fluid; once the cooling machine 700 is broken or damaged, the cooling machine 700 must be repaired or replaced with a new one by the manufacturer of the cooling machine 700; briefly, if the manufacturer does not manufacture the cooling machine 700 anymore, or if the machine tool 600 is located at such a position where is hard to be reached by the manufacturer of the cooling machine 700 to replace or to repair the cooling machine 700, the machine tool 600 will not operate normally once the cooling machine 700 is shut down thereby resulting in a severe delay of working procedures. The operation of the machine tool 600 and the cooling machine 700 can only be restarted again only when repair of the cooling machine 700 is accomplished.

The present invention is, therefore, arisen to obviate or at least mitigate the above mentioned disadvantages.

### SUMMARY OF THE INVENTION

An object of the present invention is to provide a cooling system for working fluid of machine tool capable of being assembled to various machine tools. Such cooling system for working fluid includes a cooling host and a heat exchanger, in which the cooling host is a commercial available cooling host and can be individually replaced by another, thus the cooling host can be assembled and repaired easily. The present invention is applied to a machine tool with working fluid; with the application of a controller, the temperature of the working fluid can be detected and controlled efficiently. The cooling system according to the present invention is totally different form the conventional custom made cooling machine.

Another object of the present invention is to possess the ability to monitor the operation of the working fluid circulation pipeline so as to ensure the machine tool operating normally and to prevent the machine tool from being damaged due to the abnormal condition of the working fluid circulation. As compared to the conventional, a fluid sensing device is assembled in the working fluid circulation pipeline to monitor the condition of the fluid operation. Upon detecting the operation of the fluid in the working fluid circulation pipeline works abnormally, such as the flow of the fluid is too low, is ceased, or the water level of the fluid is insufficient to sustain normal circulation of the fluid, the fluid sensing device can send a message back to stop the machine tool or the cooling host, thereby preventing the machine tool or the cooling host from continuously operating in such conditions.

Another yet object of the present invention is to provide a new application for using the cooling host of a commercial available air conditioner. By connecting with the heat exchanger, the working fluid is cooled down; in detail, heat exchanger is applied, via the temperature difference between the high temperature working fluid and low temperature refrigerants, to cool of the working fluid. Such application is quite different from the conventional, which applies a vaporizer to connect with the cooling system to cool down the working fluid in the system with gas states.

To achieve the above and other objects, a cooling system for working fluid of machine tool includes a cooling host and a temperature sensing and controlling device being assemblable in a machine tool. The temperature sensing and controlling device is provided to detect a temperature parameter of the machine tool. The cooling host includes a heat exchanger and a refrigerant circulation pipeline. The heat exchanger is connected to the refrigerant circulation pipeline and a working fluid circulation pipeline of the machine tool. According to the temperature parameter, the temperature sensing and controlling device turns on or off the cooling host, or adjusts operation modes of the cooling host. The cooling host is a commercial available cooling host. Based on this, the working fluid in the machine tool is flowed into the heat exchanger via the working fluid circulation pipeline, and the cooling host delivers refrigerants to the heat exchanger through the refrigerant circulation pipeline, thereby allowing the working fluid in the working fluid circulation pipeline to exchange heat with the refrigerant circulation pipeline via the heat exchanger, and the cooling host can be freely replaced by any commercial available cooling host, base on the damage condition thereof. Consequently, the cooling system for working fluid of machine tool is applicable to various machine tools, and the cooling host thereof can be replaced by any commercial available cooling host.

The aforementioned temperature sensing and controlling device includes one or two temperature sensors. In the case of one temperature sensor, the temperature sensor is provided to detect the temperature of the working fluid and control the temperature within an interval; when the temperature of the working fluid exceeds to a value which is higher than a preset value with a certain range, the cooling device is then started so as to allow the working fluid and the refrigerant undergoing heat exchange in the heat exchanger, thereby cooling the working fluid. While when the temperature of the working fluid is lower to a value which is lower than the preset value with a certain range, the cooling device is shut down. In the case of two temperature sensors, one of the two temperature sensor is assembled in the working fluid storage tank to measure the temperature of the working fluid therein, and the other temperature sensor is assembled in the machine tool to measure the temperature of the machine tool or the environmental temperature as a reference temperature. The temperature sensing and controlling device compares the difference between the temperature of the working fluid and the reference temperature to control the cooling host; that is, when the aforementioned difference reaches a preset value, the cooling host is started, thus the working fluid and the refrigerant undergo heat exchange in the heat exchanger, thereby cooling the working fluid; while when the aforementioned difference does not reach to the preset value, the cooling host will be shut down.

Note that, when the controller is provided to turn on or turn off the cooling host, the cooling host is the constant-frequency outdoor host. Once the variable-frequency outdoor host is applied as the cooling host, the operation of the cooling host can be adjusted according to the temperature difference; when the temperature of the working fluid is too high, the operating frequency of the cooling host is increased; while when the temperature of the working fluid is closed to the set temperature or the reference temperature, the operating frequency of the cooling host is decreased.

The cooling system for working fluid of machine tool further includes a fluid sensing device connected to the controller to detect the circulation states of the working fluid in the working fluid circulation pipeline. Existing machine tools do not assemble the aforementioned fluid sensing device. When the fluid sensing device detects the circulation state of the working fluid in the working fluid circulation pipeline is abnormal, the fluid sensing device will send a message or signal to the control to stop the operation of the cooling host or to stop the operation of the machine tool. with the application of the fluid sensing device, the cooling host or the machine tool will stop operation upon the circulation of the working fluid is ceased or the circulation state of the working fluid is abnormal, thereby preventing the cooling host or the machine tool from continuously operating to lead severe damages to the cooling host or the machine tool. The working fluid circulation pipeline includes pipes and connects to the heat exchanger, so that the working fluid circulation pipeline delivers the high temperature working fluid into the heat exchanger to undergo heat exchange with the refrigerants so as to cool down the working fluid for machining or cooling purposes. The high temperature refrigerants, absorbing the heat of the working fluid via the heat exchanger, are delivered to the cooling host via the refrigerant circulation pipeline for cooling thereby the working fluid can be cooled down repeatedly.

A method for using the cooling system for working fluid of machine tool is provided and includes following steps. Step a: starting the machine tool to allow the working fluid flowing into the working fluid circulation pipeline. Step b: detecting the temperature parameter of the machine tool by the temperature sensing and controlling device to start the cooling host to allow the operation of the refrigerant circulation pipeline of the cooling host. Step c, allowing the working fluid in the working fluid circulation pipeline to undergo heat exchange with the refrigerant circulation pipeline in the heat exchanger. Step d, allowing the temperature sensing and controlling device to control the operation of the cooling host or to loop Step c based on the temperature of the working fluid in Step c.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic diagram showing a conventional machine tool externally connected to a cooling machine;

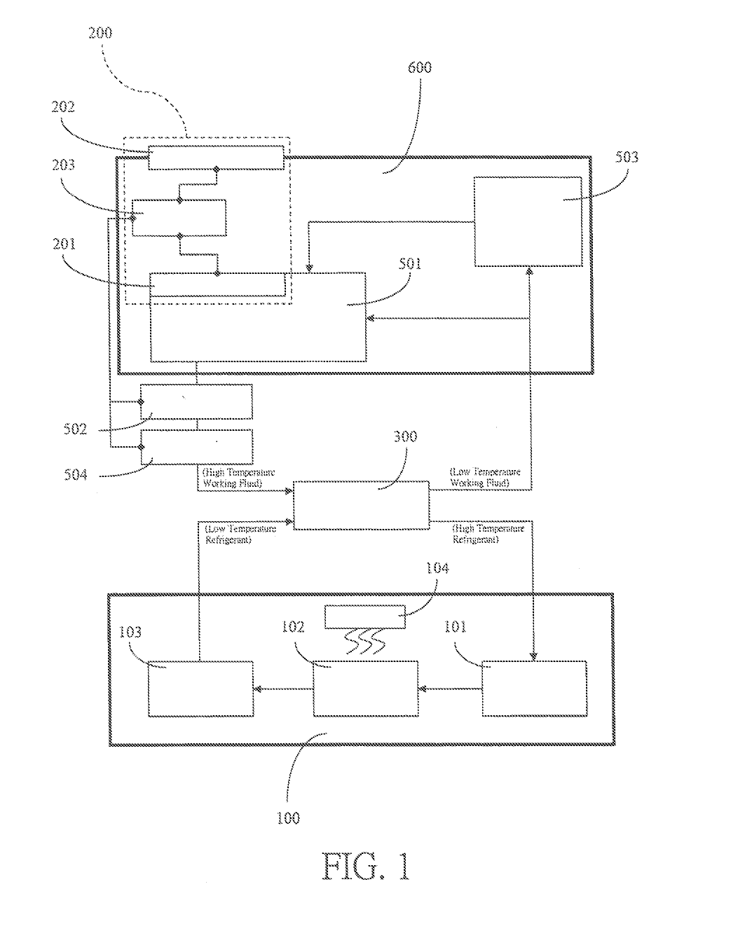

FIG. 2 is a schematic diagram showing a cooling system for working fluid of machine tool according to the present invention;

FIG. 3 is an enlarged view of the cooling system for working fluid of machine tool in FIG. 2 according to the present invention;

FIG. 4 is another enlarged view of the cooling system for working fluid of machine tool in FIG. 2 according to the present invention; and

FIG. 5 is a schematic diagram of an immerse-type heat exchanger.

### DETAILED DESCRIPTION OF THE PREFERRED EMBODIMENTS

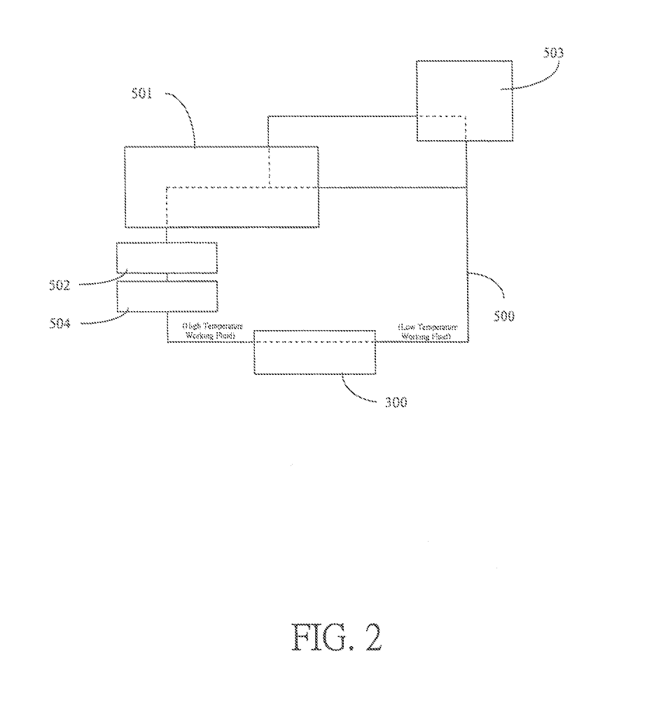

The present invention is an open-type cooling system of a machine tool, using a cooling host of a commercial available air conditioner to combine with a heat exchanger and using fluid as cooling media, as shown in FIG. 2, illustrating an embodiment of the present invention. The cooling system for working fluid of machine tool according to the present invention is applied to a machine tool 600 with working fluid. The machine tool 600 typically includes a machining region (machining tank) 503, a working fluid storage tank 501 and structures possessing similar functionalities. The working fluid storage tank 501 is provided to store the working fluid.

The cooling system for working fluid of machine tool according to the present invention includes a cooling host 100 and a temperature sensing and controlling device 200. The temperature sensing and controller device 200 can be assembled in the machine tool 600 and is provided to detect a temperature parameter of the machine tool 600. The cooling host 100 includes a heat exchanger 300 and a refrigerant circulation pipeline 400. The heat exchanger 300 is connectable with a working fluid circulation pipeline 500 of the machine tool 600, and the cooling host 100 is turned on or off, or operation modes of the cooling host 600 are adjusted, according to the temperature parameter detected by the temperature sensing and controlling device 200. The cooling host 100 is a commercial available cooling host. Based on this, the working fluid in the machine tool 600 is flowed into the heat exchanger 300 via the working fluid circulation pipeline 500, and the cooling host 100 delivers refrigerants to the heat exchanger 300 through the refrigerant circulation pipeline 400, thereby allowing the cooling of the working fluid by heat exchange. Furthermore, the cooling host 100 can be freely replaced by any commercial available cooling host depended on the damage condition of the cooling host 100. The cooling host 100 is an outdoor host of an air conditioner, and the outdoor host of the air conditioner is one of a constant-frequency outdoor host and a variable-frequency outdoor host; namely, the cooling host 100 can be any kinds of commercial available cooling host and not limited to the variable-frequency host or to the constant-frequency host.

Please refer to FIG. 2, in which the temperature sensing and controlling device 200 includes a first temperature sensor 201, a second temperature sensor 202 and a controller 203. When the machine tool 600 starts to operate, the temperature sensing and controlling device 200 is launched to detect the working fluid. The first temperature sensor 201 of the temperature sensing and controlling device 200 detects the temperature of the working fluid in the working fluid storage tank 501 so as to control the temperature of the working fluid. The second temperature sensor 202 detects the temperature of the machine tool 600 and/or the environmental temperature as a reference temperature; a temperature difference between the fluid temperature (the temperature detected by the first temperature sensor 201) and the reference temperature (the temperature detected by the second temperature sensor 202) is compared by the controller 203 to generate a temperature parameter, and based on the temperature parameter, the controller 203 undergoes temperature-difference control to the cooling host 100. When the controller 203 controls the temperature of the working fluid according to the aforementioned temperature difference, the value of the temperature is controlled within the tolerance of the set temperature; further, such control can be a switch control or a ratio control. Since the working fluid storage tank 501 is connected to the working fluid circulation pipeline 500, the working fluid in the working fluid storage tank 501 communicates the working fluid in the working fluid circulation pipeline 500. Therefore, besides detecting the temperature of the working fluid in the working fluid storage tank 501, the first temperature sensor 201 can also detect the temperature of the working fluid in the working fluid circulation pipeline 500; thus, the first temperature sensor 201 is not limited to detect the temperature of the working fluid in the working fluid storage tank 501.

Note that, when the temperature-difference control is not necessary, the second temperature sensor 202 can be omitted. Under this arrangement, the controller 203 of the temperature sensing and controlling device 200 controls the operation of the cooling host 100 according to the temperature parameter generated from the temperature of the working fluid detected by the first temperature sensor 201. Furthermore, if a predetermined temperature parameter, for example, 25 Celsius degrees, is set to the machine tool 600, the temperature sensing and controlling device 200 will control a cooling ratio of the cooling host 100 by comparing the temperature parameter with the predetermined temperature parameter; for example, when the temperature parameter exceeds the predetermined temperature parameter (in this case, 25 Celsius degrees) during machining, the controller 203 of the temperature sensing and controlling device 200 controls the cooling host 100 to operate so as to adjust the temperature parameter close to the predetermined temperature parameter.

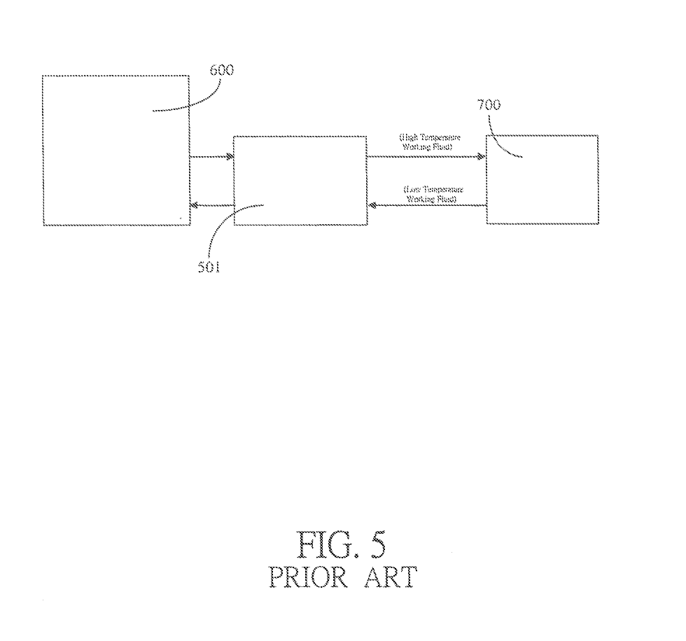

Referring to FIG. 2 to FIG. 5, when the temperature control satisfies the setting of the temperature sensing and controlling device 200, the cooling host is started to operate via the controller 203. Note that, when the controller 203 is provided to turn on or turn off the cooling host 100, the cooling host 100 is the constant-frequency outdoor host. Once the variable-frequency outdoor host is applied as the cooling host 100, the operation of the cooling host 100 can be adjusted according to the temperature difference; when the temperature of the working fluid is too high, the operating frequency of the cooling host 100 is increased; while when the temperature of the working fluid is closed to the set temperature or the reference temperature, the operating frequency of the cooling host 100 is decreased. The working fluid circulation pipeline 500 includes a plurality of pipes and connects to the working fluid storage tank 501 and the heat exchanger 300; the pumping device 502 pumps out the working fluid with relative higher temperature from the working fluid storage tank 501, and the high temperature fluid is delivered to the heat exchanger 300 through the working fluid circulation pipeline 500. The heat exchanger 300 can be an individual device or combined with the machine tool 600, as described following. The high temperature fluid undergoes heat exchange with the relatively low temperature refrigerants in the heat exchanger; since the temperature of the working fluid is higher than that of the refrigerant, the heat of the working fluid is carried by the refrigerant. After the heat exchange is finished, the working fluid with relatively low temperature is output by the heat exchanger 300, and the relatively low temperature working fluid is delivered back to the working fluid storage tank 501 through the working fluid circulation pipeline 500, or delivered to the machining region (machining tank) 503 of the machine tool 600 for machining.

As mentioned above, the heat exchanger 300 is an individual device; that is, the heat exchanger 300 is not assembled to the machine tool 600, but embodiments are not limited thereto. In some implementation aspects, the heat exchanger 300 is assembled to the machine tool 600, or assembled in the working fluid storage tank 501.

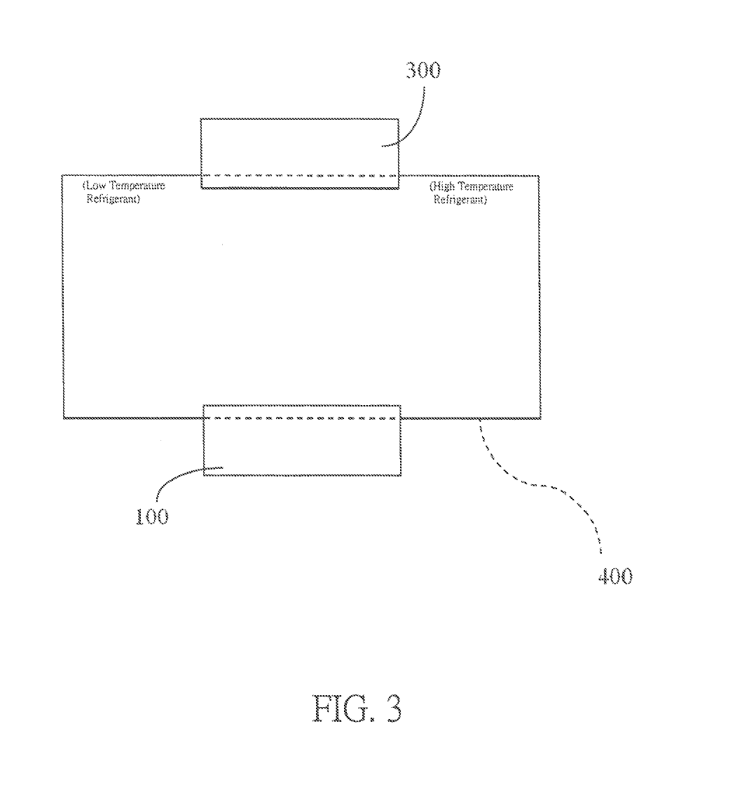

As shown in FIG. 2 and FIG. 3, the cooling system for working fluid of machine tool further includes a fluid sensing device 504 connected to the controller 203 to detect circulation states of the working fluid in the working fluid circulation pipeline 500. The fluid sensing device 504 is assembled to any position of the working fluid circulation pipeline 500 capable of contacting with the fluid therein. When the fluid sensing device 504 senses that the circulation of the working fluid in the working fluid circulation pipeline 500 is ceased, the fluid sensing device 504 sends a message or a signal to the controller 203 to assign the controller 203 stopping the operation of the cooling host 100, stopping the operation of the machine tool 600, or simultaneously stopping the operations of both the cooling host 100 and the machine tool 600.

The aforementioned condition where the circulation of the working fluid is ceased can occur upon the pumping device 502 is broken or upon the working fluid is insufficient; with the application of the fluid sensing device 504, the cooling host 100 or the machine tool 600 will stop operation upon the circulation of the working fluid is ceased, thereby preventing the cooling host 100 or the machine tool 600 from continuously operating to lead severe damages to the cooling host 100 or the machine tool 600; also, the fluid sensing device 504 ensures that the heat exchange function of the heat exchanger 300 can work normally. The fluid sensing device 504 can be, a differential pressure fluid sensor, a gravity fluid sensor, a maglev piston fluid sensor, a pulse-initiating rotor fluid sensor, an infrared fluid sensor, or any fluid sensor capable of alerting signals according to the condition of the fluid operations.

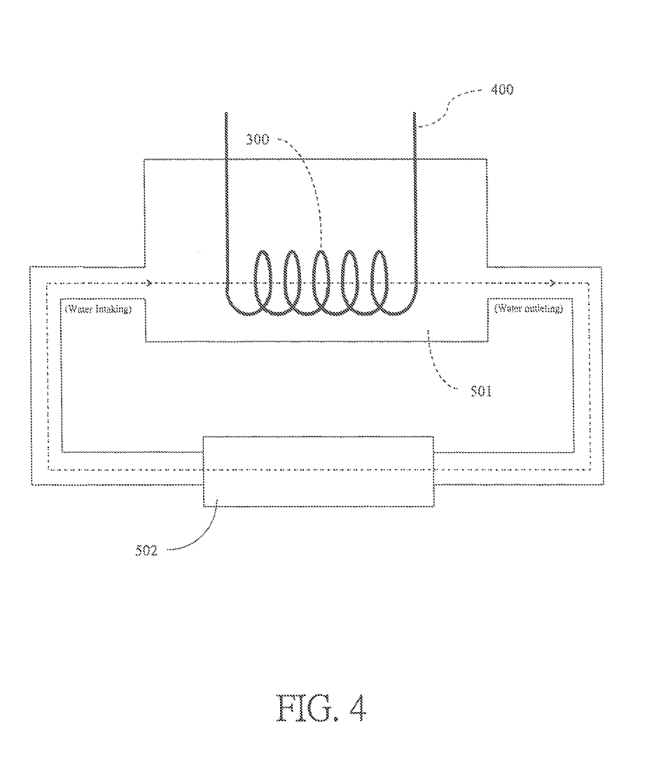

As shown in FIG. 4, the heat exchanger 300 is combined with the working fluid circulation pipeline 500 and the refrigerant circulation pipeline 400. With structural design, the media in the two circulation pipelines undergo heat exchange. In the exemplary embodiment of the present invention, the refrigerant circulation pipeline 400 in the heat exchanger 300 is stacked with the working fluid circulation pipeline 500 in the heat exchanger 300. The heat exchanger 300, using metal pipes as a primary structure, can be a spiral heat exchanger, plat heat exchanger or shell and tube heat exchanger; alternatively, the heat exchanger 300 can be an immerse-type heat exchanger in which the refrigerant circulation pipeline 400 is embedded in the working fluid storage tank 501. The heat of the high temperature working fluid in the working fluid circulation pipeline 500 is, through the endothermic reaction upon vaporizing the low-temperature and liquid-state refrigerants to the high-temperature, low-pressure and gas-state refrigerants, delivered to the refrigerants in the refrigerant circulation pipeline 400 to be absorbed by the refrigerants, thereby cooling the working fluid rapidly.

Please refer to FIG. 2 and FIG. 4, in which one end of the refrigerant circulation pipeline 400 is connected to the cooling host 100 with pipes. The cooling host 100 at least includes a compressor 101 and a condenser 102, and can be constant-pressured or variable-pressured. The cooling host 100 further includes, according to users requirements, a capillary tube (expansion valve) 103 and a cooler 104, or devices with similar functions. The high temperature and gas-state refrigerants, absorbing the heat of the working fluid in the heat exchanger 300, are then delivered to the compressor 101 of the cooling host 100 via the refrigerant circulation pipeline 400, thereby the compressor 102 converting the low-pressure and gas-state refrigerants into high-pressure and gas-state refrigerants, so that primary heat dissipation is accomplished by the aforementioned pressurizing process. Thereafter, the high-pressure and gas-state refrigerants are converted into liquid—state refrigerant through the condenser 102 with the aids of the cooler 104; at this time, most of the heats in the refrigerants are released out and eliminated from the cooling host 100 via the cooler 104. The cooler 104 can be a fan mechanism, a water flow mechanism or the like. With the application of the compressor 101 and the condenser 102, the high temperature and gas-state refrigerants are completely reduced to low-temperature liquid-state refrigerants; and with the application of the capillary tube (expansion valve) 103, the pressure of the refrigerants can be adjusted to a proper value to enhance the heat absorbing efficiency of the liquid-state refrigerants upon vaporization. Finally, the refrigerants are delivered back to the heat exchanger 300 via the pipes, thereby allowing cooling the working fluid repeatedly.

Based on the above, it can be realized that the cooling host 100 is an outdoor host of a commercial available air conditioner. Therefore, when the cooling host 100 is broken or damaged, the user only needs to buy components of the outdoor host or the whole outdoor host for repairing the unworked cooling host 100; hence, the operation of the machine tool 600 can be restarted rapidly and efficiently.

A method for using the cooling system for working fluid of machine tool is also provided and includes following steps. Step a: starting the machine tool to allow the working fluid flowing into the working fluid circulation pipeline. Step b: detecting the temperature parameter of the machine tool by the temperature sensing and controlling device to start the cooling host to allow the operation of the refrigerant circulation pipeline of the cooling host. Step c, allowing the working fluid in the working fluid circulation pipeline to undergo heat exchange with the refrigerant circulation pipeline in the heat exchanger. Step d, allowing the temperature sensing and controlling device to control the operation of the cooling host or to loop Step c based on the temperature of the working fluid in Step c.

Furthermore, the fluid sensing device 504 of the cooling system according to the present invention can protect the machine tool 600, the cooling host 100 and the heat exchanger 300 from being damaged unexpectedly upon the circulation of the working fluid is abnormal. Moreover, since the cooling host 100 and the heat exchanger 300 can be operated and assembled individually, thus can be repaired and reassembled easily upon being damaged, thereby allowing the cooling system for working fluid of machine tool to rework in a short period and increasing the market dominance of the machine tool 600 with the present invention.

Although particular embodiments of the invention have been described in detail for purposes of illustration, various modifications and enhancements may be made without departing from the spirit and scope of the invention. Accordingly, the invention is not to be limited except as by the appended claims.

1. A cooling system for working fluid of machine tool, comprising a cooling host and a temperature sensing and controlling device being assemblable in a machine tool, wherein the temperature sensing and controlling device is provided to detect a temperature parameter of the machine tool;
the cooling host comprising a heat exchanger and a refrigerant circulation pipeline, the heat exchanger connected to a working fluid circulation pipeline connectable with the machine tool, and the cooling host being turned on or off, or operation modes of the cooling host being adjusted, according to the temperature parameter of the temperature sensing and controlling device, and the cooling host being a commercial available cooling host;
whereby, the working fluid in the machine tool is flowed into the heat exchanger via the working fluid circulation pipeline, and the cooling host delivers refrigerants to the heat exchanger through the refrigerant circulation pipeline, thereby allowing the temperature of the working fluid in the working fluid circulation pipeline to exchange heat with the refrigerant circulation pipeline via the heat exchanger, and the cooling host can be freely replaced by any commercial available cooling host based on the damage condition thereof.

2. The cooling system for working fluid of machine tool as claimed in claim 1, wherein the cooing host is an outdoor host of an air conditioner.

3. The cooling system for working fluid of machine tool as claimed in claim 2, wherein the cooing host is one of a constant-frequency outdoor host and a variable-frequency outdoor host.

4. The cooling system for working fluid of machine tool as claimed in claim 1, wherein the temperature sensing and controlling device includes a first temperature sensor and a controller, the first temperature sensor detects the temperature of the working fluid in the working fluid circulation pipeline, the controller controls the cooling host according to the temperature detected by the first temperature sensor.

5. The cooling system for working fluid of machine tool as claimed in claim 1, wherein the temperature sensing and controlling device includes a first temperature sensor, a second temperature sensor and a controller, the first temperature sensor detects the temperature of the working fluid in the working fluid circulation pipeline, and second temperature sensor detects the temperature of the machine tool and/or the environmental temperature, the controller compares the temperature detected by the first temperature sensor with that detected by the second temperature sensor to control the cooling host according to a temperature difference between the temperature detected by the first temperature sensor and that detected by the second temperature sensor.

6. The cooling system for working fluid of machine tool as claimed in claim 4, further comprising a fluid sensing device connected to the controller to detect circulation states of the working fluid in the working fluid circulation pipeline, wherein when the fluid sensing device senses that the circulation of the working fluid in the working fluid circulation pipeline is ceased, the controller stops the operation of the cooling host, the operation of the machine tool, or simultaneously stops the operations the cooling host and the machine tool.

7. The cooling system for working fluid of machine tool as claimed in claim 5, further comprising a fluid sensing device connected to the controller to detect circulation states of the working fluid in the working fluid circulation pipeline, wherein when the fluid sensing device senses that the circulation of the working fluid in the working fluid circulation pipeline is ceased, the controller stops the operation of the cooling host, the operation of the machine tool, or simultaneously stops the operations the cooling host and the machine tool.

8. The cooling system for working fluid of machine tool as claimed in claim 4, wherein the machine tool has a predetermined temperature parameter, the controller compares the temperature of the machine tool detected by the temperature sensing and controlling device with the predetermined temperature parameter to control a cooling ratio of the cooling host.

9. The cooling system for working fluid of machine tool as claimed in claim 5, wherein the machine tool has a predetermined temperature parameter, the controller compares the temperature of the machine tool detected by the temperature sensing and controlling device with the predetermined temperature parameter to control a cooling ratio of the cooling host.

10. The cooling system for working fluid of machine tool as claimed in claim 1, wherein the refrigerant circulation pipeline in the heat exchanger is stacked with the working fluid circulation pipeline in the heat exchanger.

11. The cooling system for working fluid of machine tool as claimed in claim 1, further comprising a storage tank connected to the working fluid circulation pipeline to store the working fluid, wherein the heat exchanger is assembled in the storage tank.

12. A method for using the cooling system for working fluid of machine tool as claimed in claim 1, comprising:
(a) starting the machine tool to allow the working fluid flowing into the working fluid circulation pipeline;
(b) detecting the temperature parameter of the machine tool by the temperature sensing and controlling device to start the cooling host to allow the operation of the refrigerant circulation pipeline of the cooling host;
(c) allowing the working fluid in the working fluid circulation pipeline to undergo heat exchange with the refrigerant circulation pipeline in the heat exchanger; and
(d) allowing the temperature sensing and controlling device to control the operation of the cooling host or to loop the (c) step based on the temperature of the working fluid in the (c) step.
